(19) United States
(12) Patent Application Publication
(10) Pub. No.: US 2025/0336658 A1
(43) Pub. Date: Oct. 30, 2025

(54) MASS SPECTROMETRY METHOD AND MASS SPECTROMETER

(71) Applicant: SHIMADZU CORPORATION, Kyoto-shi (JP)

(72) Inventors: Hidenori TAKAHASHI, Kyoto-shi (JP); Daiki ASAKAWA, Tsukuba-shi (JP)

(21) Appl. No.: 18/877,890

(22) PCT Filed: Apr. 14, 2023
(86) PCT No.: PCT/JP2023/015198

§ 371 Date: Dec. 20, 2024

(30) Foreign Application Priority Data
Jun. 30, 2022 (JP) 2022-105802

(51) Int. Cl. H01J 49/00; H01J 49/14

(52) U.S. Cl. CPC H01J 49/0036; H01J 49/147

(57) ABSTRACT

A mass spectrometer includes: measurement execution units separate and detect product ions according to a mass-to-charge ratio, generated by irradiating a precursor ion of a sample component with an oxygen radical, a hydroxyl radical, or a nitrogen radical; a candidate molecule estimation unit to determine a candidate molecule assuming that the sample component is a compound having a heterocyclic ring containing a double bond between carbon atoms based on the mass-to-charge ratio of the precursor ion; an assumed product ion estimation unit to calculate a mass-to-charge ratio of an assumed product ion assumed to be generated by dissociation of the heterocyclic ring of the precursor ion of the candidate molecule or a bond adjacent to the heterocyclic ring; and a determination unit to determine whether the sample compound is the candidate molecule by comparing the mass-to-charge ratio of the detected product ion with th at of the assumed product ion.

### TECHNICAL FIELD

The present invention relates to a mass spectrometry method and a mass spectrometer.

### BACKGROUND ART

A heterocyclic compound is a compound having a ring composed of a plurality of kinds of elements, and is often contained in a pharmaceutical product or a sample derived from a living body. Therefore, in order to develop a new pharmaceutical product or search for a biomarker for finding a disease, a heterocyclic compound contained in a sample is analyzed.

A representative method for analyzing a compound contained in a sample is a collision-induced dissociation (CID) method. In the CID method, energy is applied to a precursor ion to accelerate the precursor ion, and the accelerated precursor ion is repeatedly collided with an inert gas such as argon, whereby the precursor ion is dissociated to generate product ions. A product ion spectrum is acquired by separating the thus generated product ions according to a mass-to-charge ratio and detecting the product ions. In addition, a plurality of candidate compounds are estimated from the mass-to-charge ratio of the precursor ion, and a set of product ion or ions generated when each of the candidate compounds is dissociated is theoretically estimated to create an estimated product ion spectrum of the candidate compound. Then, a compound contained in a sample is identified based on the degree of coincidence between the product ion spectrum obtained by actually measuring the sample and one of the estimated product ion spectra of the plurality of candidate compounds.

### CITATION LIST

### Patent Literature

Patent Literature 1: WO 2018/186286 A
Patent Literature 2: WO 2019/155725 A

### Non Patent Literature

Non Patent Literature 1: Hidenori Takahashi, Yuji Shimabukuro, Daiki Asakawa, Akihito Korenaga, Masaki Yamada, Shinichi Iwamoto, Motoi Wada, Koichi Tanaka, “Identifying Double Bond Positions in Phospholipids Using Liquid Chromatography-Triple Quadrupole Tandem Mass Spectrometry Based on Oxygen Attachment Dissociation”, Mass Spectrometry, Volume 8, Issue 2, Pages S0080, 2020

### SUMMARY OF INVENTION

### Technical Problem

The collision-induced dissociation method is an ion dissociation method in which energy is accumulated in a precursor ion until the precursor ion is dissociated. Since the energy is dispersed throughout the molecule of the precursor ion in the method, the selectivity of the position at which the precursor ion is dissociated is low. In addition, the position at which the precursor ion is dissociated depends on the magnitude of the collision energy and the gas pressure of the collision gas, and the spectrum pattern of the product ion greatly varies. Therefore, even if a product ion generated from each candidate compound is theoretically estimated, it is difficult to obtain an estimated product ion spectrum having a high degree of coincidence with the product ion spectrum obtained by actual measurement. As a result, there remain a large number of candidate compounds having the same degree of coincidence in the product ion spectrum, so that it is difficult to narrow down the candidate compounds and identify a sample component with high accuracy.

An object of the present invention is to provide a technique capable of enhancing identification accuracy of a sample component.

### Solution to Problem

A mass spectrometry method according to the present invention made to solve the above problems includes:
irradiating a precursor ion derived from a sample component with an oxygen radical, a hydroxyl radical, or a nitrogen radical, and generating product ions;
separating the product ions according to a mass-to-charge ratio, and detecting the product ions;
determining a candidate molecule assuming that the sample component is a compound having a heterocyclic ring containing a double bond between carbon atoms, based on a mass-to-charge ratio of the precursor ion;
calculating a mass-to-charge ratio of an assumed product ion assumed to be generated by dissociation of the heterocyclic ring of the precursor ion of the candidate molecule or by dissociation of a bond adjacent to the heterocyclic ring; and
determining whether or not the sample component is the candidate molecule by comparing the mass-to-charge ratio of the detected product ion with the mass-to-charge ratio of the assumed product ion.

A mass spectrometer according to the present invention made to solve the above problems includes:
a reaction chamber into which a precursor ion derived from a sample component is introduced;
a measurement execution unit configured to irradiate the precursor ion introduced into the reaction chamber with an oxygen radical, a hydroxyl radical, or a nitrogen radical, separate product ions according to a mass-to-charge ratio and detect the product ions, the product ions being generated from the precursor ion by irradiation of the radical;
a candidate molecule estimation unit configured to determine a candidate molecule assuming that the sample component is a compound having a heterocyclic ring containing a double bond between carbon atoms, based on a mass-to-charge ratio of the precursor ion;
an assumed product ion estimation unit configured to calculate a mass-to-charge ratio of an assumed product ion assumed to be generated by dissociation of the heterocyclic ring of the precursor ion of the candidate molecule or by dissociation of a bond adjacent to the heterocyclic ring; and
a determination unit configured to determine whether or not the sample component is the candidate molecule by comparing the mass-to-charge ratio of the detected product ion with the mass-to-charge ratio of the assumed product ion.

### Advantageous Effects of Invention

The present inventors have found that when a heterocyclic compound containing a double bond between carbon atoms is irradiated with an oxygen radical, a hydroxyl radical, or a nitrogen radical, the radical adheres to a site of the double bond between carbon atoms contained in a heterocyclic ring, and radical induced dissociation proceeds with the site as a starting point. In the radical induced dissociation of the heterocyclic compound, in many cases, a precursor ion is dissociated as it is at a position of a double bond to which a radical is attached, but the precursor ion may be dissociated at a position of a bond adjacent to the double bond (a single bond contained in the heterocyclic ring or a bond adjacent to the heterocyclic ring). In the present invention, a candidate molecule is determined assuming that the sample component is a compound having a heterocyclic ring containing a double bond between carbon atoms, based on the mass-to-charge ratio of the precursor ion. Then, a mass-to-charge ratio of an assumed product ion assumed to be generated by dissociation of a heterocyclic ring of the precursor ion of the candidate molecule or by dissociation of a bond adjacent to the heterocyclic ring is obtained and compared with a mass-to-charge ratio of a product ion detected by actual measurement. When these mass-to-charge ratios match, it is determined that the sample component is the candidate molecule. When these mass-to-charge ratios do not match, there is high possibility that the sample component is not a heterocyclic compound containing a double bond between carbon atoms. As described above, in the present invention, by determining whether or not the sample component is a heterocyclic compound containing a double bond between carbon atoms, it is possible to narrow down compound candidates, and enhance the identification accuracy of the sample component.

### BRIEF DESCRIPTION OF DRAWINGS

FIG. 1 A schematic configuration diagram of a liquid chromatograph mass spectrometer, which is one embodiment of a mass spectrometer according to the present invention.

FIG. 2 A schematic configuration diagram of a radical generator in the mass spectrometer of the present embodiment.

FIG. 3 A schematic configuration diagram of a transport path of a radical in the mass spectrometer of the present embodiment.

FIG. 4 A flowchart according to one embodiment of a mass spectrometry method according to the present invention.

FIG. 5 A view illustrating a molecular structure and a radical attachment/dissociation mechanism of mequitazine.

FIG. 6 A CID spectrum of mequitazine.

FIG. 7 A radical attachment/dissociation MS spectrum of mequitazine.

FIG. 8 Molecular structures of two candidate molecules narrowed down based on a result of analysis using the radical attachment/dissociation MS spectrum.

FIG. 9 A view illustrating a molecular structure and a radical attachment/dissociation mechanism of reserpine.

FIG. 10 A CID spectrum of reserpine.

FIG. 11 A radical attachment/dissociation MS spectrum of reserpine.

FIG. 12 A view illustrating a molecular: structure and a radical attachment/dissociation mechanism of thiamine.

FIG. 13 A radical attachment/dissociation MS spectrum of thiamine.

### DESCRIPTION OF EMBODIMENTS

Hereinafter, an embodiment of a mass spectrometer and a mass spectrometry method according to the present invention will be described with reference to the drawings. The present embodiment is intended to identify an unknown compound contained in a sample to be analyzed, and can be suitably used, for example, when an unknown compound contained in a sample derived from a living body or an environmental substance is identified, and a lead compound of a drug or a compound serving as a biomarker of a disease is searched for.

### 1. CONFIGURATION OF MASS SPECTROMETER OF PRESENT EMBODIMENT

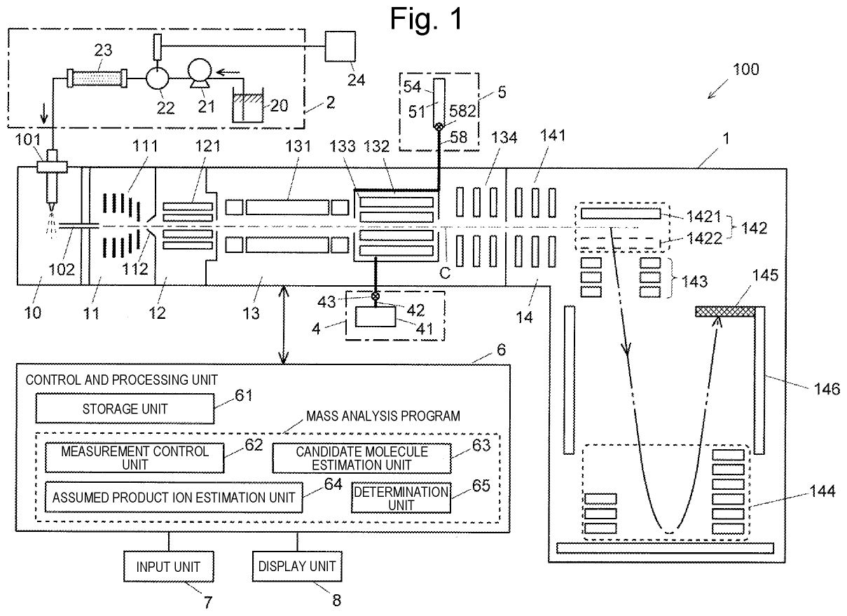

FIG. 1 is a configuration diagram of a main part of a liquid chromatograph mass spectrometer 100 in which a mass spectrometer 1 of the present embodiment is combined with a liquid chromatograph 2.

The liquid chromatograph 2 includes a mobile phase container 20 that accommodates a mobile phase, a liquid feeding pump 21 that feeds the mobile phase, an injector 22, and a column 23. In addition, to the injector 22, an autosampler 24 is connected that introduces a plurality of liquid samples into the injector in a predetermined order.

The mass spectrometer 1 includes a main body including an ionization chamber 10 at substantially atmospheric pressure and a vacuum chamber, and a control and processing unit 6. The vacuum chamber includes a first intermediate vacuum chamber 11, a second intermediate vacuum chamber 12, a third intermediate vacuum chamber 13, and an analysis chamber 14 in this order from the ionization chamber 10, and has a configuration of a multi-stage differential exhaust system with an increasing degree of vacuum in this order.

The ionization chamber 10 is provided with an electrospray ionization probe (ESI probe) 101 for nebulizing a liquid sample while imparting electric charges to the liquid sample. Sample components separated in the column 23 of the liquid chromatograph 2 are sequentially introduced into the ESI probe 101.

The ionization chamber 10 and the first intermediate vacuum chamber 11 communicate with each other through a small-diameter heated capillary 102. In the first intermediate vacuum chamber 11, an ion lens 111 is disposed that includes a plurality of ring-shaped electrodes having different diameters and focuses ions in the vicinity of an ion optical axis C that is a central axis of a flight path of ions.

The first intermediate vacuum chamber 11 and the second intermediate vacuum chamber 12 are separated from each other by a skimmer 112 having a small hole at its top. In the second intermediate vacuum chamber 12, an ion guide 121 is disposed that includes a plurality of rod electrodes disposed so as to surround the ion optical axis C and focuses ions in the vicinity of the ion optical axis C.

In the third intermediate vacuum chamber 13, there are disposed: a quadrupole mass filter 131 configured to separate ions according to their mass-to-charge ratios; a collision cell 132 including a multipole ion guide 133 inside; and an ion guide 134 for transporting the ions discharged from the collision cell 132. The ion guide 134 includes a plurality of ring-shaped electrodes having the same diameter.

A collision gas supplier 4 is connected to the collision cell 132. The collision gas supplier 4 includes: a collision gas source 41; a gas introduction flow path 42 for introducing gas from the collision gas source 41 into the collision cell 132; and a valve 43 for opening and closing the gas introduction flow path 42. As the collision gas, for example, an inert gas such as a nitrogen gas or an argon gas is used.

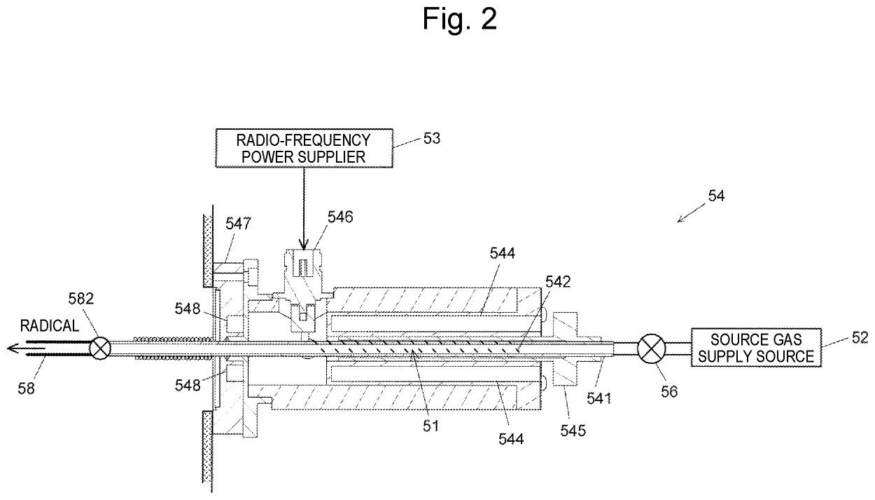

In addition, a radical supplier 5 is also connected to the collision cell 132. The radical supplier 5 has a configuration similar to that described in Patent Literature 5 and Non Patent Literature 1. As illustrated in FIG. 2, the radical supplier 5 includes a radical source 54 in which a radical generation chamber 51 is formed inside, a vacuum pump (not illustrated) that exhausts the radical generation chamber 51, a raw gas supply source 52 that feeds gas (raw gas) as a source of radicals, and a radio-frequency power supplier 53. A valve 56 for adjusting a flow rate of the raw gas is provided in a flow path from the raw gas supply source 52 to the radical generation chamber 51.

FIG. 2 is a cross-sectional view of the radical source 54. The radical source 54 has a tubular body 541 made of a dielectric such as alumina (for example, aluminum oxide, quartz, or aluminum nitride), and a space inside the tubular body 541 serves as the radical generation chamber 51. The tubular body 541 is fixed by a plunger 545 in a state in which the tubular body 541 is inserted into inside a hollow cylindrical magnet 544. A helical antenna 542 (broken line in FIG. 2) is wound around the outer periphery of a portion located inside the magnet 544 of the tubular body 541.

The radical source 54 is provided with a radio-frequency power input part 546. The radio-frequency power supplier 53 supplies radio-frequency power to the radio-frequency power input part 546. The radical source 54 further includes a flange 547 for fixing a tip portion of the radical source 54. The flange 547 accommodates inside a hollow cylindrical magnet 548 having the same diameter as the magnet 544 and forming a pair with the magnet 544. The magnets 544 and 548 generate a magnetic field inside the tubular body 541 (radical generation chamber 51) to easily generate and maintain plasma by the action.

A transport pipe 58 for transporting radicals generated in the radical generation chamber 51 to the collision cell 132 is connected to an outlet end of the radical source 54 via a valve 582. The transport pipe 58 is an insulating pipe, and for example, a quartz glass pipe or a borosilicate glass pipe can be used.

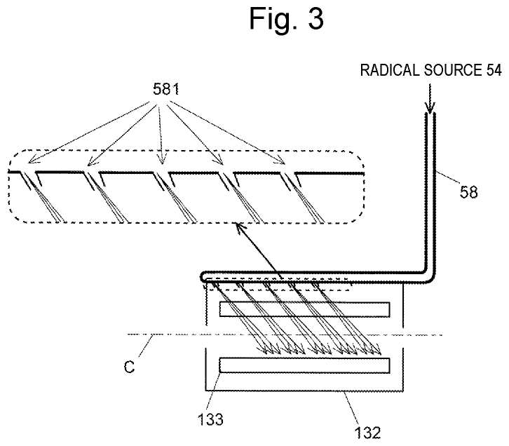

As illustrated in FIG. 3, in the transport pipe 58, a plurality of head parts 581 are provided in a portion disposed along a wall surface of the collision cell 132. Each of the plurality of head parts 581 is provided with an inclined cone-shaped irradiation port, and is irradiated with radicals in a direction intersecting the central axis (ion optical axis C) of a flight direction of ions. As a result, ions flying inside the collision cell 132 can be uniformly irradiated with radicals.

The analysis chamber 14 includes: an ion transport electrode 141 for transporting the incident ions from the third intermediate vacuum chamber 13; an orthogonal acceleration electrode 142 including a pair of an expulsion electrode 1421 and a lead-in electrode 1422 disposed in such a manner as to face each other across the incident optical axis of the ions (an orthogonal acceleration area); an acceleration electrode 143 that accelerates the ions ejected to a flight space by the orthogonal acceleration electrode 142; a reflectron electrode 144 that forms a return path for the ions within the flight space; an ion detector 145; and a flight tube 146 that defines the periphery of the flight space. The ion detector 145 is, for example, an electron multiplier or a microchannel plate.

The control and processing unit 6 has a function of controlling the operation of each unit described above and storing and analyzing data obtained by the ion detector 145. The control and processing unit 6 includes a storage unit 61. The storage unit 61 also stores a method file describing measurement conditions for performing measurement to be described later, and information for converting a time-of-flight of an ion into a mass-to-charge ratio of the ion.

The control and processing unit 6 includes, as functional blocks, a measurement control unit 62, a candidate molecule estimation unit 63, an assumed product ion estimation unit 64, and a determination unit 65. The entity of the control and processing unit 6 is a general personal computer to which an input unit 7 and a display unit 8 are connected, and embodies the functional blocks described above by causing a processor to execute a mass analysis program installed in advance. The measurement control unit 62 of the present embodiment operates as a measurement execution unit according to the present invention together with the liquid chromatograph 2 and the mass spectrometer 1.

### 2. PROCEDURE OF MASS SPECTROMETRY IN PRESENT EMBODIMENT

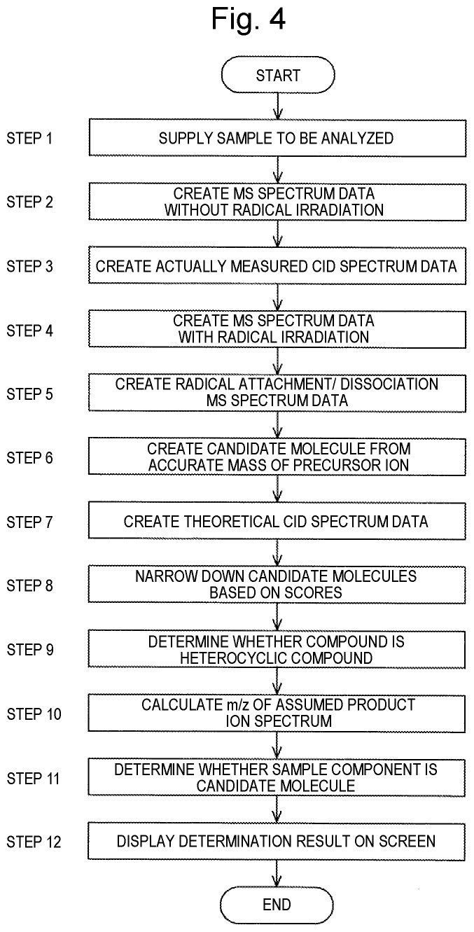

Next, a procedure for an analysis using the liquid chromatograph mass spectrometer 100 of the present embodiment will be described as an example of the mass spectrometry method according to the present invention, with reference to FIG. 4. This analysis example is intended to search for unknown components, particularly heterocyclic compounds, contained in a liquid sample.

When the user introduces the sample to be analyzed into the autosampler 24 and gives an instruction to start the analysis, the measurement control unit 62 first exhausts the inside of the radical generation chamber 51 to a predetermined degree of vacuum by a vacuum pump, and introduces the raw gas (water vapor in the present embodiment) from the raw gas supply source 52 into the radical generation chamber 51 at a predetermined flow rate. At this time, the radio-frequency power supplier 53 is not operated, and the valve 58 is also closed.

The measurement control unit 62 supplies the liquid sample from the autosampler 24 into the injector 22 (step 1). The liquid sample supplied into the injector 22 is introduced into the column 23 along with the flow of the mobile phase fed from the mobile phase container 20 by the liquid feeding pump 21. The components in the liquid sample are separated inside the column 23, sequentially introduced into the ESI probe 101 of the mass spectrometer 1, and ionized.

While the sample component is introduced into the ESI probe 101, the measurement control unit 62 first repeatedly executes MS scan measurement without irradiation of radicals. When ions are detected at an intensity equal to or higher than a predetermined threshold in the MS scan measurement, MS scan measurement without irradiation of radicals, product ion scan measurement by CID (hereinafter, the measurement is also referred to as “CID measurement”), MS scan measurement with irradiation of oxygen radicals, and product ion scan measurement by oxygen radical attachment/dissociation (hereinafter, also referred to as “radical attachment/dissociation measurement”) are sequentially performed.

In the MS scan measurement without irradiation of radicals, ions generated by the ESI probe 101 are transported as they are to the orthogonal acceleration electrode 142 without being subjected to mass separation and sent to the flight space, and the ions are sequentially detected by the ion detector 145 by flying a predetermined flight path in the flight space. The output signals from the ion detector 145 are sequentially transmitted to the control and processing unit 60 and stored in the storage unit 61. When ions are detected at an intensity equal to or higher than a predetermined threshold in the MS scan measurement, the time-of-flight of an ion is converted into the mass-to-charge ratio of the ion based on the information stored in the storage unit 61, and thus MS spectrum data is created from the measurement data (step 2). Then, the ions detected at an intensity equal to or greater than the threshold described above are determined as precursor ions. Hereinafter, the MS spectrum (data) created from the MS scan measurement without irradiation of radicals is also referred to as “MS spectrum (data) without radical irradiation”.

In the CID measurement, the valve 58 of the radical supplier 5 is opened at the same time as the start of the measurement to introduce water vapor into inside the collision cell 132. In general CID measurement, an inert gas such as argon gas is fed from the collision gas supplier 4 to the collision cell 132, but in the present analysis example, water vapor is fed from the raw gas supply source 52 of the radical supplier 5 in order to easily switch from the collision gas to the radicals at high speed when radical attachment/dissociation measurement is performed after CID measurement. Ions generated by the ESI probe 101 enter into the quadrupole mass filter 131, precursor ions are selected, collision energy of a predetermined magnitude is applied, and the ions enter into the collision cell 132. In the inside of the collision cell 132, a precursor ion collides with a gas molecule of water vapor and dissociated, and a product ion (fragment ion) is generated. The product ion generated in the collision cell 132 is transported to the orthogonal acceleration unit 142 and sent to the flight space. After flying along a predetermined flight path, the product ion is sequentially detected by the ion detector 145. At the same time as the end of the CID measurement (or after the end of the measurement of the sample to be analyzed), the time-of-flight of the ion is converted into the mass-to-charge ratio of the ion based on the information stored in the storage unit 61, and product ion spectrum data is created (step 3). Hereinafter, the product ion spectrum (data) created from the CID measurement is also referred to as “actually measured CID spectrum (data)”.

In the MS scan measurement with irradiation of oxygen radicals, the radio-frequency power supplier 53 of the radical supplier 5 is operated at the same time as the start of the measurement to generate radicals from water vapor in the radical generation chamber 51. The radicals produced here include oxygen radicals. The generated radicals are introduced into the inside of the collision cell 132. Ions generated by the ESI probe 101 are directly introduced into the collision cell 132 as they are without being subjected to mass separation by the quadrupole mass filter 131, and oxygen radicals or the like adhere to part of the introduced ions to generate product ions. The product ions referred to herein include fragment ions generated by dissociation due to a radical attachment reaction of ions generated from sample components, and adduct ions in a state where radicals are attached to the ions generated from sample components. The product ions are transported to the orthogonal acceleration electrode 142 together with unreacted ions and sent to the flight space. After flying along a predetermined flight path, the product ions are sequentially detected by the ion detector 145. At the same time as the end of the MS scan measurement with irradiation of oxygen radicals (or after the end of the measurement of the sample to be analyzed), the time-of-flight of the ion is converted into the mass-to-charge ratio of the ion based on the information stored in the storage unit 61, and MS spectrum data is created (step 4). Hereinafter, the MS spectrum (data) created from the MS scan measurement with irradiation of oxygen radicals is also referred to as “radical irradiation MS spectrum (data)”.

In the radical attachment/dissociation measurement, while oxygen radicals and the like are continuously introduced into inside the collision cell 132, precursor ions are selected by the quadrupole mass filter 131 from the ions generated by the ESI probe 101 and enter into the collision cell 132. In the inside of the collision cell 132, oxygen radicals adhere to precursor ions to generate product ions. Similarly to the above, the product ions referred to herein include fragment ions generated by dissociation of precursor ions derived from a sample component due to a radical attachment reaction, and adduct ions in a state where radicals are attached to the precursor ions. The product ions are transported to the orthogonal acceleration electrode 142 together with unreacted precursor ions and sent to the flight space. After flying along a predetermined flight path, the product ions are sequentially detected by the ion detector 145. At the same time as the end of the radical attachment/dissociation measurement (or after the end of the measurement of the sample to be analyzed), the time-of-flight of the ion is converted into the mass-to-charge ratio of the ion based on the information stored in the storage unit 61, and product ion spectrum data is created (step 5). Hereinafter, the product ion spectrum (data) created from the radical attachment/dissociation measurement is also referred to as “radical attachment/dissociation MS spectrum (data)”.

When the measurement of the liquid sample is completed, the candidate molecule estimation unit 63 obtains accurate mass of the precursor ion from the MS spectrum data without radical irradiation, and determines a candidate molecule from the accurate mass (step 6). In a time-of-flight mass separator used in the present embodiment, since the accurate mass of an ion is obtained, a composition formula can be estimated from the accurate mass of the precursor ion, and a molecular structure that can be taken from the composition formula can be estimated to determine a candidate molecule. The number of candidate molecules determined here is not limited to one, and usually there may be a plurality of candidate molecules.

The candidate molecule estimation unit 63 theoretically estimates fragment ions that can be generated from the molecular structure of each candidate molecule by computer calculation (in silico) to generate theoretical CID spectrum data (step 7). The candidate molecule estimation unit 63 is not limited to one that generates a theoretical CID spectrum by itself, and may access an external site via a network such as the Internet to generate a theoretical CID spectrum. As such a site, for example, MetFlag is known. The candidate molecule estimation unit 63 compares a mass peak in the theoretical CID spectrum data with a mass peak in the actually measured CID spectrum data, and narrows down, from among the previously obtained candidate molecules, to a candidate molecule in which the matching degree (score) of both pieces of spectrum data falls on a predetermined reference (step 8).

Next, the candidate molecule estimation unit 63 compares mass peaks present in MS spectrum data without radical irradiation and MS spectrum data with radical irradiation. Then, it is confirmed whether a mass peak corresponding to an adduction to which an oxygen radical is attached to the precursor ion exists in the MS spectrum data with radical irradiation, and when the adduct ion exists, it is estimated that the sample component is highly likely to be a heterocyclic compound (step 9). When it is estimated that the sample component is highly likely to be a heterocyclic compound, a predetermined value is added to the score of the candidate molecule, which is a heterocyclic compound (or/and a predetermined value is subtracted from the score of candidate molecules other than the heterocyclic compound). Conversely, when it is estimated that there is high possibility that the sample component is not a heterocyclic compound, a predetermined value is added to the score of the candidate molecule other than the heterocyclic compound (or/and a predetermined value is subtracted from the score of the candidate molecule, which is the heterocyclic compound).

Subsequently, the assumed product ion estimation unit 64 calculates a mass-to-charge ratio of an assumed product ion generated by dissociation of the heterocyclic ring or a bond adjacent to the heterocyclic ring for a compound (hereinafter, the heterocyclic compound is also referred to as a “double-bonded heterocyclic compound”) having a heterocyclic ring containing a double bond between carbon atoms among the candidate molecules narrowed down by the above processing (step 10).

In the radical induced dissociation of the heterocyclic compound, in many cases, a precursor ion is dissociated as it is at a position of a double bond to which a radical is attached, but the precursor ion may be dissociated at a position of a bond adjacent to the double bond (a single bond contained in the heterocyclic ring or a bond adjacent to the heterocyclic ring). Therefore, for example, in a candidate molecule in which it is known in advance that the heterocyclic ring of the assumed molecule is dissociated at the position of the double bond, only the mass-to-charge ratio of an assumed product ion generated by dissociation of the heterocyclic ring at the position of the double bond may be determined. Then, for other assumed product ions, it is sufficient only to obtain both the mass-to-charge ratio of an assumed product ion generated by dissociation of the heterocyclic ring of the assumed molecule at the position of the double bond and the mass-to-charge ratio of one or more assumed product ions generated by dissociation of the heterocyclic ring of the assumed molecule at the position of the bond adjacent to the double bond.

When the mass-to-charge ratio of the assumed product ion is calculated for each of the candidate molecules that are the double-bonded heterocyclic compounds, the determination unit 65 confirms whether or not a mass peak corresponding to each of the assumed product ions exists in the radical attachment/dissociation MS spectrum data. When there is a mass peak corresponding to an assumed product ion of any of the candidate molecules, it is determined that the sample component is highly likely to be the candidate molecule (step 11). On the other hand, in a case where there is no mass peak corresponding to the assumed product ion of any candidate molecule, it is determined that there is high possibility that the sample component is not a double-bonded heterocyclic compound. The determination unit 65 displays a determination result on the screen of the display unit 8 together with a molecular structure of each of the candidate molecules, information on whether or not the candidate molecule is a heterocyclic compound, and a score (step 12).

As described above, in the present embodiment, based on the MS spectrum data without radical irradiation, the MS spectrum data with radical irradiation, the actually measured CID spectrum data, and the spectrum data with radical irradiation of the sample component, a candidate molecule is determined based on the accurate mass of the precursor ion. Then, a score is calculated by comparing the theoretical CID spectrum with the actually measured CID spectrum, whether or not the compound is a heterocyclic compound is estimated based on the presence or absence of an adduction, and the score is added (or subtracted). Finally, it is determined whether or not a mass peak corresponding to an assumed product ion assumed to be generated in a case where the sample component is assumed to be a double-bonded heterocyclic compound is present in the spectrum with radical irradiation. By performing these pieces of processing, it is possible to narrow down candidate molecules of the sample component, and enhance the identification accuracy of the sample component.

### 3. EXAMPLES

### First Example

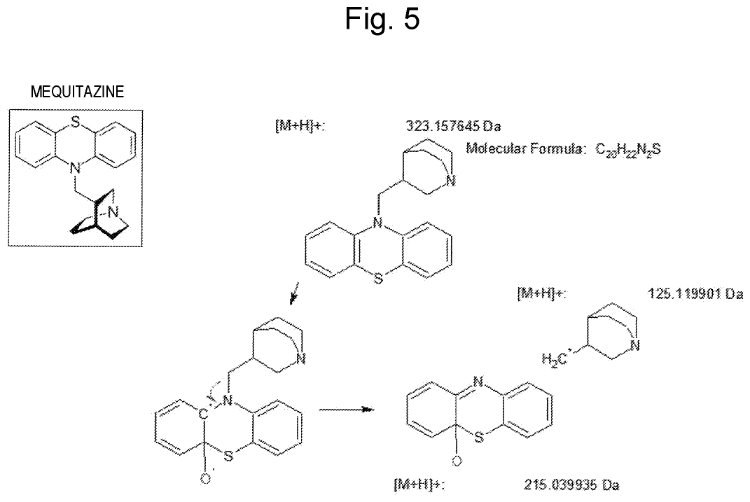

As a first example, a result obtained by confirming by an experiment, for example, that precursor ions of a double-bonded heterocyclic compound are dissociated at positions of double bonds contained in a heterocyclic ring by irradiation with oxygen radicals will be described. In the first example, mequitazine was measured. Mequitazine is a compound having the molecular structure illustrated in FIG. 5, and is included in pharmaceuticals and the like. FIG. 5 also illustrates the mechanism of radical attachment/dissociation assumed for mequitazine.

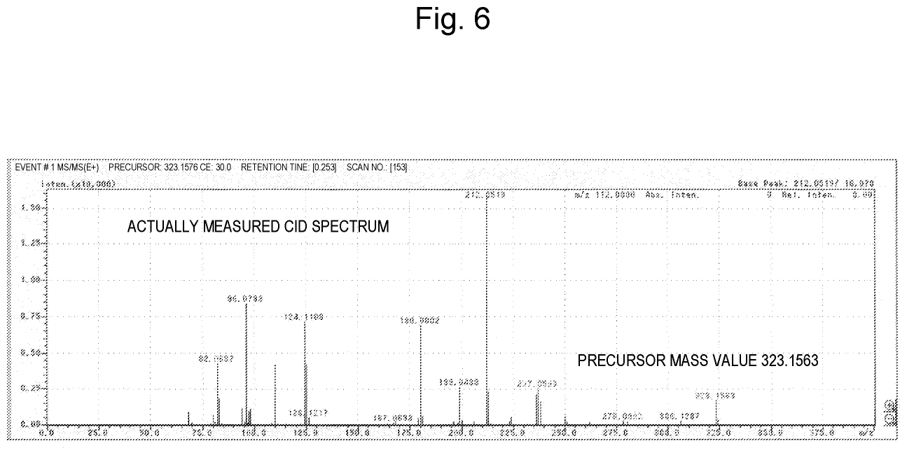

FIG. 6 is an actually measured CID spectrum of mequitazine. This actually measured CID spectrum was obtained by CID measurement in which ions (proton addition ions) having an observed mass-to-charge ratio of 323.1563 were used as precursor ions. When this actually measured CID spectrum data was analyzed by MetFlag, the score of mequitazine, which is a correct compound, was 19th. In this example, mequitazine, which is a known compound, is measured. However, when an unknown component in a sample is measured, it is not clear as to which order the score of a correct compound appears. In the conventional mass spectrometry method, it is necessary to create a standard sample for each of the candidate molecules having high scores, perform CID measurement to acquire actually measured CID spectrum data, and determine which of the candidate molecules the sample component is, and it takes time and effort to prepare a large number of standard samples and measure them. In addition, there was a case where, for some candidate molecules, it was not always possible to prepare a standard sample by isolating the compound.

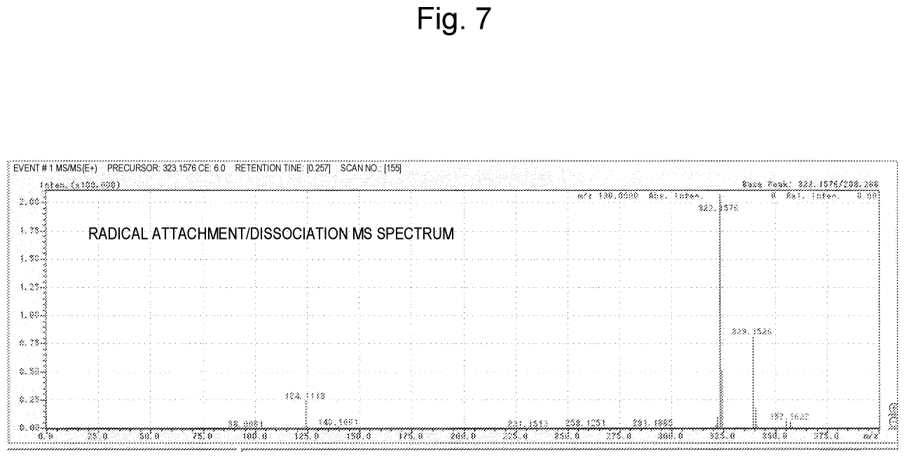

FIG. 7 is a radical attachment/dissociation MS spectrum of mequitazine. The radical attachment/dissociation MS spectrum was obtained by irradiating precursor ions having a mass-to-charge ratio of 323.1576 with oxygen radicals generated from water vapor as a raw gas.

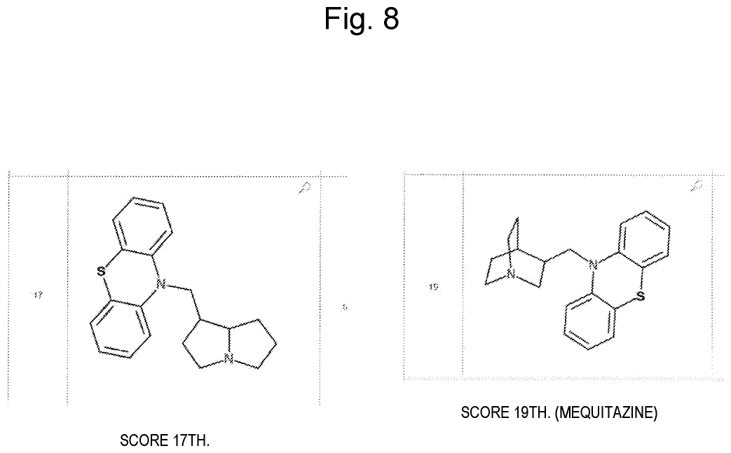

In the first example, among the candidate molecules, those that are double-bonded heterocyclic compounds were extracted, a mass-to-charge ratio of an assumed product ion generated by dissociation of the precursor ions at the positions of the double bonds included in the heterocyclic rings was determined, and whether or not a mass peak of ions having the mass-to-charge ratio was present on the radical attachment/dissociation MS spectrum was confirmed. In the first example, a mass peak (m/z: 124.1118) corresponding to the assumed product ion illustrated in FIG. 5 was confirmed only for the two kinds of heterocyclic compounds illustrated in FIG. 8 among the top 19 candidate molecules presented in MetFlag. As a result, it can be estimated that the sample component is highly likely to be one of the two kinds of candidate molecules. As a result, the candidate molecules are narrowed down to two candidate molecules without performing CID measurement for all the candidate molecules at higher ranks, and the identification accuracy of the sample component is improved.

### Second Example

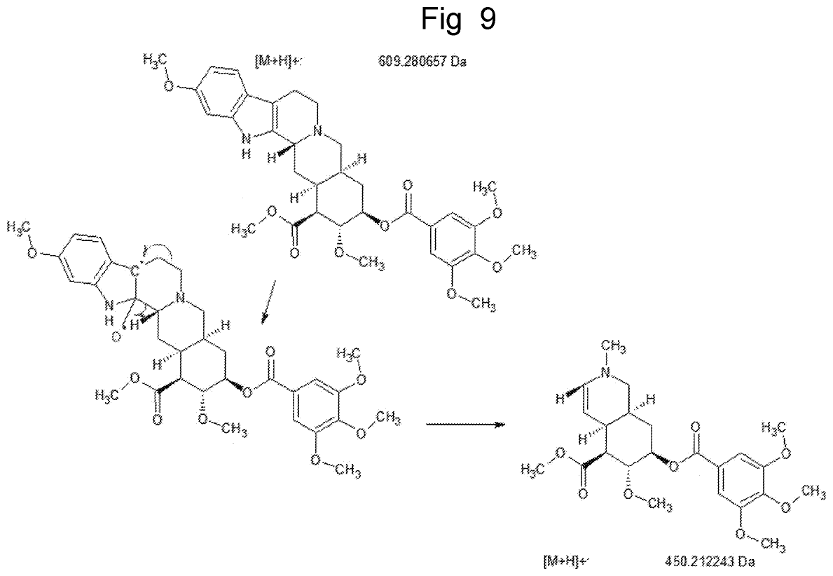

As a second example, reserpine belonging to alkaloid, which is a kind of pharmaceutical, will be described with reference to FIGS. 9 to 11. Reserpine belongs to a group of compounds called indole, which have a structure in which a benzene ring and a pyrrole ring are fused as illustrated in FIG. 9. FIG. 9 also illustrates the mechanism of radical attachment/dissociation assumed for reserpine.

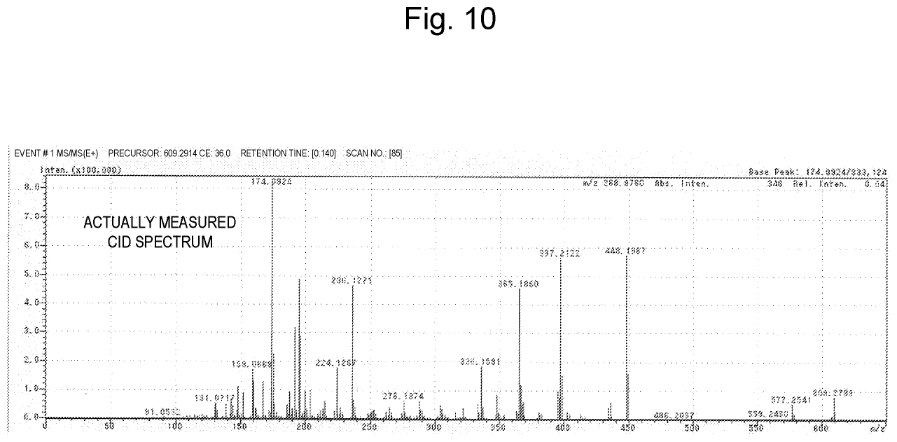

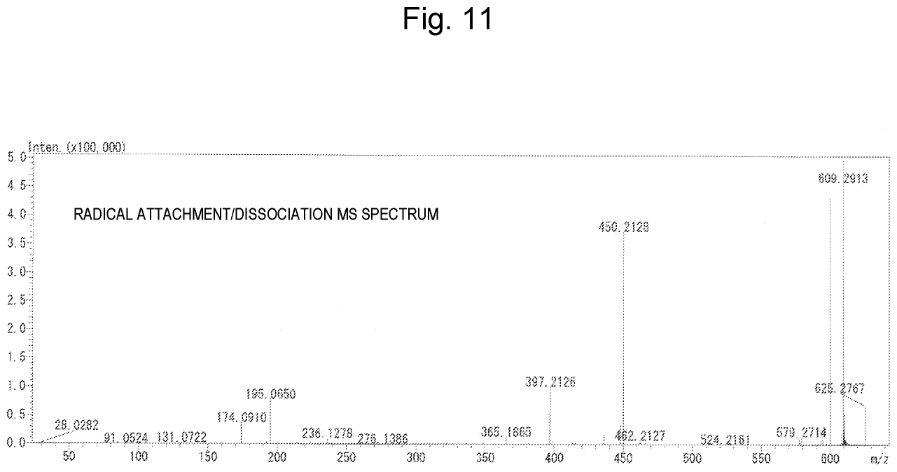

FIG. 10 is an actually measured CID spectrum of reserpine, and FIG. 11 is a radical attachment/dissociation MS spectrum of reserpine. In the radical attachment/dissociation MS spectrum of FIG. 11, a mass peak having a mass-to-charge ratio of 450.2128, which is not observed in the actually measured CID spectrum of FIG. 10 and corresponds to a product ion generated by dissociation of a heterocyclic ring of a precursor ion, appears.

### Third Example

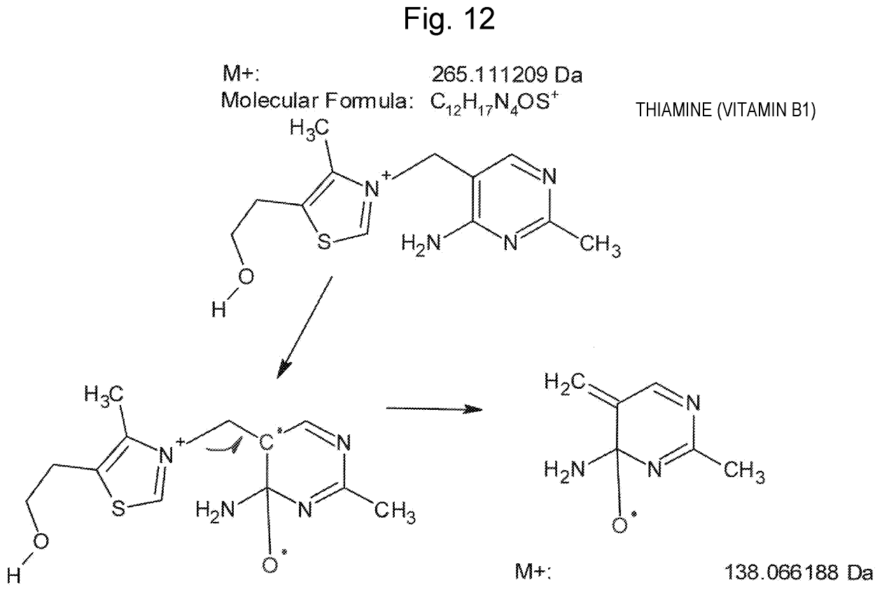

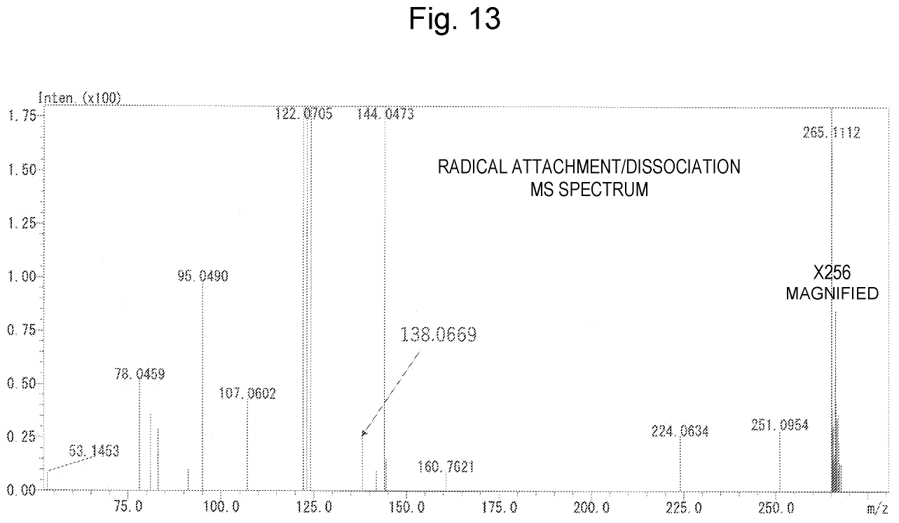

As a third example, thiamine (vitamin B1) will be described with reference to FIGS. 12 and 13. FIG. 12 also illustrates a molecular structure of thiamine and a mechanism of radical attachment/dissociation assumed for thiamine.

FIG. 13 is a radical attachment/dissociation MS spectrum of thiamine. Also in the radical attachment/dissociation MS spectrum of FIG. 13, a mass peak having a mass-to-charge ratio of 138.0669, which corresponds to a product ion generated by dissociation of a heterocyclic ring of a precursor ion, appears. However, the intensity of the mass peak of the product ion generated by dissociation of the heterocyclic ring of the precursor ion is small as compared with the radical attachment/dissociation MS spectrum of mequitazine illustrated in FIG. 7 and the radical attachment/dissociation MS spectrum of reserpine illustrated in FIG. 11. The present inventors performed measurement for various compounds, and then, it has been found that radical attachment/dissociation tends to be less likely to occur as the conjugation of electrons in a heterocyclic ring is higher. As a result of experiments conducted by the present inventors, it has been found that radical attachment/dissociation does not occur in a benzene ring, which is consistent with this tendency. It is considered that, from the fact that although the heterocyclic ring of thiamine contains a nitrogen atom, the heterocyclic ring of thiamine is a cyclic conjugated compound, the heterocyclic ring of the precursor ion was not easily dissociated. On the other hand, it has been found that indole or imidazole having a pyrrole ring is likely to dissociate a heterocyclic ring, and many product ions are generated. Therefore, the mass spectrometer and the mass spectrometry method of the above-described embodiment are considered to be useful for identification of, in particular, these compounds.

Each of the above-described embodiment and examples is merely an example, and can be appropriately changed according to the spirit of the present invention.

The mass spectrometry method and the mass spectrometer according to the present invention are not limited to the compounds listed in the above first to third examples, and can be used for analysis of various heterocyclic compounds. Specifically, the heterocyclic compound is, for example, a heterocyclic compound containing at least one of a boron atom, a nitrogen atom, a phosphorus atom, a sulfur atom, and an oxygen atom in the heterocyclic ring, and is, for example, borole, pyrrole, imidazole, phosphole, thiophene, or furan. Specific compound names include, for example, thiamine (vitamin B1), nicotinic acid amide (a type of vitamin B3), pyridoxine (a type of vitamin B6), tryptophan (a type of amino acid), mequitazine (an antihistamine), reserpine (a tranquilizer/blood pressure depressant), epinastine (a medicine for pollinosis), and clozapine (a medicine for schizophrenia).

In the above-described embodiment, the MS scan measurement without irradiation of radicals, the CID measurement, the MS scan measurement with irradiation of oxygen radicals, and the radical attachment/dissociation measurement are performed to acquire spectrum data for each of them, but it is not essential in the present invention to perform all of these measurements. It is possible to estimate at least whether or not the molecule is a candidate molecule that is a double-bonded heterocyclic compound simply by performing radical attachment/dissociation measurement to acquire a radical attachment/dissociation MS spectrum. In addition, in the above examples, four measurements are continuously performed, but each of the measurements may be performed individually. In this case, it is sufficient that an inert gas such as argon gas only is supplied from the collision gas supplier 4 at the time of CID measurement. Furthermore, when the molecular structure that can be taken from the accurate mass-to-charge ratio of precursor ions obtained from the MS spectrum without radical irradiation is limited, or when the number of candidate molecules estimated from the molecular structure based on the analysis result using a method other than mass spectrometry such as the nuclear magnetic resonance method or the crystal sponge method is a certain number or smaller (for example, 10 or fewer), the CID measurement and the calculation of the score based on the comparison between the mass peak of the theoretical CID spectrum and the mass peak of the actually measured CID spectrum may be omitted.

The adduct ion to which the oxygen radical is attached also appears in the radical attachment/dissociation MS spectrum, but when the sample to be analyzed contains an oxide, there is a possibility that an ion having the same mass-to-charge ratio as the ion to which the oxygen radical is attached is generated from the oxide, and there is a case where both ions cannot be discriminated from each other. Therefore, it is preferable to confirm the presence or absence of adduct ions by individually performing MS scan measurement without irradiation of radicals and MS scan measurement with irradiation of oxygen radicals as described above and comparing both measurement results. Alternatively, instead of performing MS scan measurement with irradiation of oxygen radicals, as a raw gas (water vapor or oxygen gas) used at the time of radical attachment/dissociation measurement, a raw gas substituted with oxygen having a mass number of 18 may be used, and the presence or absence of an adduct ion may be determined from the presence or absence of an adduction to which oxygen having a mass number of 18 is attached.

Although the liquid chromatograph mass spectrometer is used in the above examples, a gas chromatograph mass spectrometer may be used. Alternatively, only a mass spectrometer may be used by isolating a compound with another method without using a chromatograph. In the above examples, the orthogonal acceleration time-of-flight type is used as a rear-stage mass filter, but a mass filter of a multiple circulation type, a magnetic field sector type, or the like can be used instead. In addition, the configurations of the radical supplier and the radical transport pipe described in the above examples are merely examples, and can be appropriately changed.

It is sufficient that the accurate mass is a mass having such accuracy that the composition formula of the compound that is an unknown sample can be estimated from the precursor ion based on the accurate mass-to-charge ratio. In the above examples, the accurate mass is calculated with an accuracy of four digits after the decimal point. However, the required accuracy varies depending on the characteristics of the compound to be measured (the number of compounds having similar structures, etc.), and is not limited to the accuracy described in the above embodiment.

As the radical with which the precursor ion is irradiated, a hydrogen radical, a hydroxy radical or a nitrogen radical, for example, may be used instead of an oxygen radical. From the radical attachment/dissociation measurement performed by the present inventors so far, it has been found that irradiating various compounds with these three kinds of radicals exhibit common dissociation characteristics, and irradiating with hydroxy radicals or nitrogen radicals may be performed instead of oxygen radicals or in addition to oxygen radicals in the above examples. Hydroxyl radicals are generated together with oxygen radicals from the water vapor used in the above examples. Nitrogen radicals can be generated from air or nitrogen gas. Furthermore, as in the above examples, as a raw gas in the case of irradiating with oxygen radicals, oxygen gas or ozone gas may be used in addition to water vapor in the above examples.

In the above examples, the precursor ion passing through the collision cell 132 is irradiated with the radicals. However, an ion trap can be used instead of the collision cell 132 to capture a precursor ion in the ion trap and irradiate the precursor ion with the radicals.

### ASPECTS

It is understood by those skilled in the art that the plurality of exemplary embodiments described above are specific examples of the following aspects.

### Clause 1

A mass spectrometry method according to one aspect includes:
irradiating a precursor ion derived from a sample component with an oxygen radical, a hydroxyl radical, or a nitrogen radical, and generating product ions;
separating the product ions according to a mass-to-charge ratio, and detecting the product ions;
determining a candidate molecule in a case of assuming that the sample component is a compound having a heterocyclic ring containing a double bond between carbon atoms, based on a mass-to-charge ratio of the precursor ion;
calculating a mass-to-charge ratio of an assumed product ion assumed to be generated by dissociation of the heterocyclic ring of the precursor ion of the candidate molecule or by dissociation of a bond adjacent to the heterocyclic ring; and
determining whether or not the sample component is the candidate molecule by comparing the mass-to-charge ratio of the detected product ion with the mass-to-charge ratio of the assumed product ion.

### Clause 2

A mass spectrometer according to one aspect includes:
a reaction chamber into which a precursor ion derived from a sample component is introduced;
a measurement execution unit configured to irradiate the precursor ion introduced into the reaction chamber with an oxygen radical, a hydroxyl radical, or a nitrogen radical, separate product ions according to a mass-to-charge ratio and detect the product ions, the product ions being generated from the precursor ion by irradiation of the radical;
a candidate molecule estimation unit configured to determine a candidate molecule assuming that the sample component is a compound having a heterocyclic ring containing a double bond between carbon atoms, based on a mass-to-charge ratio of the precursor ion;
the assumed product ion estimation unit configured to calculate a mass-to-charge ratio of an assumed product ion assumed to be generated by dissociation of the heterocyclic ring of the precursor ion of the candidate molecule or by dissociation of a bond adjacent to the heterocyclic ring; and
a determination unit configured to determine whether or not the sample component is the candidate molecule by comparing the mass-to-charge ratio of the detected product ion with the mass-to-charge ratio of the assumed product ion.

in When a heterocyclic compound containing a double bond between carbon atoms is irradiated with an oxygen radical, a hydroxyl radical, or a nitrogen radical, the radical adheres to a site of the double bond between carbon atoms contained in a heterocyclic ring, and radical induced dissociation proceeds with the site as a base point. In the radical induced dissociation of the heterocyclic compound, in many cases, a precursor ion is dissociated as it is at a position of a double bond to which a radical is attached, but the precursor ion may be dissociated at a position of a bond adjacent to the double bond (a single bond contained in the heterocyclic ring or a bond adjacent to the heterocyclic ring). In the mass spectrometry method of clause 1 and the mass spectrometer of clause 2, a candidate molecule is determined assuming that the sample component is a compound having a heterocyclic ring containing a double bond between carbon atoms, based on the mass-to-charge ratio of the precursor ion. The number of candidate molecules determined based on the mass-to-charge ratio of the precursor ion is not limited to one, and there may be a plurality of candidate molecules. Then, for each of the one or more candidate molecules, a mass-to-charge ratio of an assumed product ion assumed to be generated by dissociation of a heterocyclic ring of the precursor ion of the candidate molecule or by dissociation of a bond adjacent to the heterocyclic ring is obtained and compared with a mass-to-charge ratio of a product ion detected by actual measurement. When these mass-to-charge ratios match, it is determined that the sample component is the candidate molecule. On the other hand, when these mass-to-charge ratios do not match, it is determined that there is high possibility that the sample component is not a heterocyclic compound containing a double bond between carbon atoms. As described above, in the mass spectrometry method of clause 1 and the mass spectrometer of clause 2, by determining whether or not the sample component is a heterocyclic compound containing a double bond between carbon atoms, it is possible to narrow down compound candidates, and enhance the identification accuracy of the sample component.

### Clause 3

In the mass spectrometer according to clause 2,
the sample component is a heterocyclic compound containing a nitrogen atom or a sulfur atom in the heterocyclic ring.

### Clause 4

In the mass spectrometer according to clause 2 or clause 3,
the heterocyclic ring is a pyrrole ring or an imidazole ring.

When the sample component is a heterocyclic compound containing a nitrogen atom or a sulfur atom as described in clause 3, the heterocyclic ring of the precursor ion is easily dissociated, and when the heterocyclic ring is a pyrrole ring or an imidazole ring as described in clause 4, the heterocyclic ring of the precursor ion is particularly easily dissociated. Therefore, with the mass spectrometer according to clause 3 or clause 4, the sample component can be identified with higher accuracy.

### Clause 5

In the mass spectrometer according to any one of clauses 2 to 4, furthermore,
the measurement execution unit is configured to acquire product ion spectrum data by separating product ions according to a mass-to-charge ratio and detecting the product ions, the product ions being generated by collision-induced dissociation of the precursor ion, and
the candidate molecule estimation unit is configured to determine a candidate molecule based on the mass-to-charge ratio of the precursor ion and the product ion spectrum data.

In the mass spectrometer according to clause 5, furthermore, in order to determine a candidate molecule using the spectrum data of the product ion generated by collision-induced dissociation of the precursor ion, it is possible to further narrow down the number of candidate molecules, and identify the sample component with high accuracy.

### Clause 6

In the mass spectrometer according to any one of clauses 2 to 5, furthermore,
the measurement execution unit is configured to acquire first mass spectrum data by separating ions according to a mass-to-charge ratio and detecting the ions without dissociating the ions which have been generated from the sample component, and configured to acquire second mass spectrum data by irradiating the ions generated from the sample component with an oxygen radical, a hydroxyl radical, or a nitrogen radical, separating the ions according to the mass-to-charge ratio and detecting the ions, and
the candidate molecule estimation unit is configured to estimate that the sample component is a heterocyclic compound based on existence of an adduct ion which is not present in the first mass spectrum data in the second mass spectrum data.

When the sample component is a heterocyclic compound, not only the heterocyclic ring of the precursor ion is easily dissociated by radical adhesion, but also an adduct ion in which a radical is attached to a double bond of the heterocyclic ring is easily generated. The mass spectrometer according to clause 6 can determine whether or not the sample component is a heterocyclic compound based on the presence of such an adduction.

### REFERENCE SIGNS LIST

100 . . . Liquid Chromatograph Mass Spectrometer
1 . . . Mass Spectrometer
10 . . . Ionization Chamber
101 . . . Electrospray Ionization (ESI) Probe
11 . . . First Intermediate Vacuum Chamber
12 . . . Second Intermediate Vacuum Chamber
13 . . . Third Intermediate Vacuum Chamber
131 . . . Quadrupole Mass Filter
132 . . . Collision Cell
133 . . . Multipole Ion Guide
14 . . . Analysis Chamber
142 . . . Orthogonal Acceleration Electrode
144 . . . Reflectron Electrode
145 . . . Ion Detector
146 . . . Flight Tube
2 . . . Liquid Chromatograph
20 . . . Mobile Phase Container
21 . . . Liquid Feeding Pump
22 . . . Injector
23 . . . Column
24 . . . Autosampler
4 . . . Collision Gas Supplier
41 . . . Collision Gas Source
42 . . . Gas Introduction Flow Path
5 . . . Radical Supplier
51 . . . Radical Generation Chamber
52 . . . Raw Gas Supply Source
53 . . . Radio-Frequency Power Supplier
54 . . . Radical Source
541 . . . Tubular Body
542 . . . Spiral Antenna
544, 548 . . . Magnet
546 . . . Radio-Frequency Power Input Part
58 . . . Transport Pipe
6 . . . Control and Processing Unit
61 . . . Storage Unit
62 . . . Measurement Control Unit
63 . . . Candidate Molecule Estimation Unit
64 . . . Assumed Product Ion Estimation Unit
65 . . . Determination Unit
7 . . . Input Unit
8 . . . Display Unit

1. A mass spectrometry method, comprising:
irradiating a precursor ion derived from a sample component with an oxygen radical, a hydroxyl radical, or a nitrogen radical to, and generating product ions;
separating the product ions according to a mass-to-charge ratio, and detecting the product ions;
determining a candidate molecule in a case of assuming that the sample component is a compound having a heterocyclic ring containing a double bond between carbon atoms, based on a mass-to-charge ratio of the precursor ion;
calculating a mass-to-charge ratio of an assumed product ion assumed to be generated by dissociation of the heterocyclic ring of the precursor ion of the candidate molecule or by dissociation of a bond adjacent to the heterocyclic ring; and
determining whether or not the sample component is the candidate molecule by comparing the mass-to-charge ratio of the detected product ion with the mass-to-charge ratio of the assumed product ion.

2. A mass spectrometer, comprising:
a reaction chamber into which a precursor ion derived from a sample component is introduced;
a measurement execution unit configured to irradiate the precursor ion introduced into the reaction chamber with an oxygen radical, a hydroxyl radical, or a nitrogen radical, separate product ions according to a mass-to-charge ratio and detect the product ions, the product ions being generated from the precursor ion by irradiation of the radical;
a candidate molecule estimation unit configured to determine a candidate molecule assuming that the sample component is a compound having a heterocyclic ring containing a double bond between carbon atoms, based on a mass-to-charge ratio of the precursor ion;
the assumed product ion estimation unit configured to calculate a mass-to-charge ratio of an assumed product ion assumed to be generated by dissociation of the heterocyclic ring of the precursor ion of the candidate molecule or by dissociation of a bond adjacent to the heterocyclic ring; and
a determination unit configured to determine whether or not the sample component is the candidate molecule by comparing the mass-to-charge ratio of the detected product ion with the mass-to-charge ratio of the assumed product ion.

3. The mass spectrometer according to claim 2, wherein the sample component is a heterocyclic compound containing a nitrogen atom or a sulfur atom in the heterocyclic ring.

4. The mass spectrometer according to claim 3, wherein the heterocyclic ring is a pyrrole ring or an imidazole ring.

5. The mass spectrometer according to claim 2, wherein
the measurement execution unit is configured to acquire product ion spectrum data by separating product ions according to a mass-to-charge ratio and detecting the product ions, the product ions being generated by collision-induced dissociation of the precursor ion, and
the candidate molecule estimation unit is configured to determine a candidate molecule based on the mass-to-charge ratio of the precursor ion and the product ion spectrum data.

6. The mass spectrometer according to claim 2, wherein
the measurement execution unit is configured to acquire first mass spectrum data by separating ions according to a mass-to-charge ratio and detecting the ions without dissociating the ions which have been generated from the sample component, and configured to acquire second mass spectrum data by irradiating the ion generated from the sample component with an oxygen radical, a hydroxyl radical, or a nitrogen radical, separating the ions according to the mass-to-charge ratio and detecting the ions, and
the candidate molecule estimation unit is configured to estimate that the sample component is a heterocyclic compound based on existence of an adduction which is not present in the first mass spectrum data in the second mass spectrum data.
